(19) United States
(12) Patent Application Publication
(10) Pub. No.: US 2014/0139757 A1
(43) Pub. Date: May 22, 2014

(54) LIQUID CRYSTAL DISPLAY DEVICE

(71) Applicant: Japan Display Inc., Tokyo (JP)

(72) Inventors: Kazuki TAMANAGA, Tokyo (JP); Masahiro TOKITA, Tokyo (JP)

(73) Assignee: JAPAN DISPLAY INC., Tokyo (JP)

(21) Appl. No.: 14/082,294

(22) Filed: Nov. 18, 2013

(30) Foreign Application Priority Data
Nov. 20, 2012 (JP) 2012-253804

(51) Int. Cl. G02F 1/1333

(52) U.S. Cl. CPC G02F 1/13338
USPC 349/12

(57) ABSTRACT

A liquid crystal display device having a plurality of pixels arranged in a matrix form includes a liquid crystal display panel which includes: a first substrate, a second substrate, and liquid crystal sealed between the first substrate and the second substrate. The second substrate includes detection electrodes for a touch panel. Each of the pixels has a pixel electrode and a counter electrode. The counter electrode is divided into a plurality of blocks. The counter electrode in each of the divided blocks is provided in common for the respective pixels in a plurality of consecutive display lines. The counter electrode in each of the divided blocks doubles as a scanning electrode for the touch panel. The liquid crystal display device includes means which, in a low-power standby mode, detects the presence of a touch by using only the plural detection electrodes.

### CLAIM OF PRIORITY

The present application claims priority from Japanese patent application JP2012-253804 filed on Nov. 20, 2012, the content of which is hereby incorporated by reference into this application.

### BACKGROUND

The present invention relates to a liquid crystal display device, or more particularly, to a technique effectively applicable to an in-cell type liquid crystal display device incorporating a touch panel.

A display device equipped with an input device (hereinafter, also referred to as “touch sensor” or “touch panel”) that allows a user to input information by performing a touch operation (touch press operation or hereinafter, simply referred to as “touch”) with user's finger or a pen is used in mobile electronic devices such as PDAs and mobile terminals, a variety of home electric appliances, ATMs (Automated Teller Machine) and the like.

An electrostatic capacitive touch panel adapted to detect change in electrostatic capacity at a touch point is known as such a touch panel.

A so-called in-cell type liquid crystal display device which has a touch panel function incorporated in a liquid crystal display panel is known as this electrostatic capacitive touch panel (see, for example, JP-A No. 2009-258182).

In the in-cell type liquid crystal display device, counter electrodes (also called common electrodes) formed on a first substrate (so-called TFT substrate) constituting the liquid crystal display panel are divided and used as scanning electrodes for a touch panel.

### SUMMARY

In a liquid crystal display device employing a conventional out-cell type touch panel, a low-power standby mode is implemented by turning off a display operation of the liquid crystal display panel and shifting the touch panel to a rough detection mode. If a touch or swipe is made in the standby mode, detection information is transmitted from a touch-panel controller IC to a host controller, which is shifted to a normal display/normal detection mode.

The in-cell type liquid crystal display device incorporating the touch panel function is also required to have the low-power standby mode. The in-cell type liquid crystal display device having the counter electrodes doubling as a touch-panel scanning electrode (Tx) has a problem that when the scanning electrodes (Tx) are scanned with the liquid crystal display panel disabled for the display operation, a DC voltage is applied to a liquid crystal layer of the liquid crystal display panel and the seizing of the liquid crystal layer results.

The invention has been accomplished to solve the above-described problem of the prior art. In the liquid crystal display device incorporating the touch panel function, an object of the invention is to provide a technique for preventing the seizing of the liquid crystal layer, which is caused by the DC voltage applied to the liquid crystal layer of the liquid crystal display panel in the standby mode.

The above and other objects and novel features of the invention will become apparent from the description of the present invention and the accompanying drawings.

Representative features of the invention disclosed in this application are briefly summarized as follows.

(1) A liquid crystal display device having a plurality of pixels arranged in a matrix form includes a liquid crystal display panel including: a first substrate, a second substrate and liquid crystal sealed between the first substrate and the second substrate and has a structure wherein the second substrate includes a plurality of detection electrodes for a touch panel, each of the pixels includes a pixel electrode and a counter electrode, the counter electrode is divided into a plurality of blocks, the counter electrode in each of the divided blocks is provided in common for the respective pixels of a plurality of consecutive display lines, and the counter electrode in each of the divided blocks doubles as a scanning electrode for the touch panel, the liquid crystal display device including means which, in a low-power standby mode, detects the presence of a touch by using only the plural detection electrodes.

(2) A liquid crystal display device having a plurality of pixels arranged in a matrix form, includes a liquid crystal display panel including: a first substrate, a second substrate and liquid crystal sealed between the first substrate and the second substrate, and has a structure wherein the second substrate includes detection electrodes for a touch panel, each of the pixels includes a pixel electrode and a counter electrode, the counter electrode is divided into a plurality of blocks, the counter electrode in each of the divided blocks is provided in common for the respective pixels in a plurality of consecutive display lines, the counter electrode in each of the divided blocks doubles as a scanning electrode for the touch panel, and the counter electrode in each of the divided blocks is supplied with a counter voltage and a touch-panel scanning voltage, the display device including: means which, in a low-power standby mode, makes every other detection electrode of the plural detection electrodes function as a tentative scanning electrode and supplies the touch-panel scanning voltage to each of the detection electrodes functioning as the tentative scanning electrode, and means which, in the low-power standby mode, detects the presence of a touch based on a detection voltage detected by the detection electrode other than the detection electrode functioning as the tentative scanning electrode.

(3) According to the aspect (2), the liquid crystal display device further includes a driver circuit for supplying the counter voltage and the touch-panel scanning voltage to the counter electrode in each of the divided blocks, and has a structure wherein in the low-power standby mode, the driver circuit supplies the touch-panel scanning voltage to the respective detection electrodes functioning as the tentative scanning electrode.

(4) According to the aspect (2), the liquid crystal display device further includes a plurality of first switch circuits which are each provided at each of the plural detection electrodes functioning as the tentative scanning electrode and connected to each of the detection electrodes functioning as the tentative scanning electrode, and has a structure wherein in the low-power standby mode, the plural first switch circuits are sequentially turned ON to supply the touch-panel scanning voltage to the detection electrodes functioning as the tentative scanning electrode.

(5) According to the aspect (2), the liquid crystal display device further includes a plurality of integration circuits which are each provided at each of the plural detection electrodes and connected to each of the detection electrodes, and has a structure wherein the integration circuits connected to the plural detection electrodes functioning as the tentative scanning electrode are connected to the plural detection electrodes functioning as the tentative scanning electrode via second switch circuits, and in the low-power standby mode, the second switch circuits are turned OFF and the integration circuits connected to the plural detection electrodes functioning as the tentative scanning electrodes are turned OFF.

The following is a brief description on the effects offered by the representative features of the invention disclosed in the present application.

The liquid crystal display device incorporating the touch panel function of the invention is adapted to prevent the seizing of the liquid crystal layer, which is caused by the DC voltage applied to the liquid crystal layer of the liquid crystal display panel in the standby mode.

These features and advantages of the invention will be apparent from the following more particular description of preferred embodiment of the invention, as illustrated in the accompanying drawings.

### BRIEF DESCRIPTION OF THE DRAWINGS

FIG. 1 is an exploded perspective view schematically showing a structure of an in-cell type liquid crystal display device having a touch panel incorporated in a liquid crystal display panel;

FIG. 2 is a diagram illustrating a counter electrode and a detection electrode in the liquid crystal display device shown in FIG. 1;

FIG. 3 is a schematic sectional view showing in enlarged dimension a part of the cross section of a display part of the liquid crystal display device shown in FIG. 1;

FIG. 4 is a block diagram schematically showing the overall structure of the touch panel in the in-cell type liquid crystal display device that is the premise of the invention;

FIG. 5 is a diagram for explaining the detection principle of the touch panel in the in-cell type liquid crystal display device that is the premise of the invention;

FIG. 6 is a timing chart of a touch detection operation of the touch panel in the in-cell type liquid crystal display device that is the premise of the invention;

FIG. 7 is a circuit diagram showing a more detailed circuit configuration of the detector circuit shown in FIG. 4;

FIG. 8 is a timing chart for illustrating operations of the circuit shown in FIG. 7;

FIG. 9 is a chart for illustrating timings at which a touch-on-panel is detected and at which pixel writing is performed; and

FIG. 10 is a diagram for illustrating an operation of detecting the presence of a touch in a low-power standby mode according to an embodiment of the invention.

### DESCRIPTION OF THE PREFERRED EMBODIMENTS The embodiment of the invention will hereinbelow be described in detail with reference to the accompanying drawings.

It is noted that identical elements in all the drawings for illustrating the embodiment will be referred to by like reference numerals and will be explained only once.

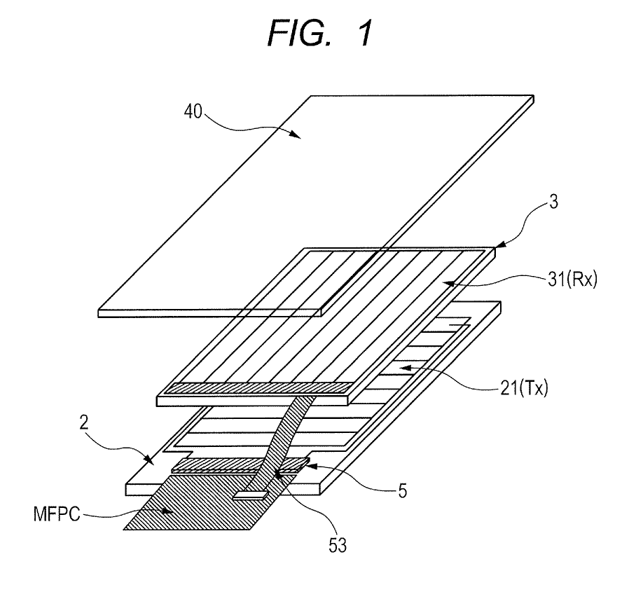

FIG. 1 is an exploded perspective view schematically showing a structure of an in-cell type liquid crystal display device having a touch panel incorporated in a liquid crystal display panel.

In FIG. 1, a first substrate (hereinafter referred to as “TFT substrate”) is indicated at 2, a second substrate (hereinafter, referred to as “CF substrate”) indicated at 3, a counter electrode (also referred to as “common electrode”) indicated at 21, an LCD driver IC indicated at 5, a main flexible printed circuit represented by MFPC, a front window indicated at 40 and a flexible wiring board indicated at 53.

In the liquid crystal display device shown in FIG. 1, a touch panel substrate used in a normal touch panel is downsized by dividing a back-side transparent conductive film (CD) on the CF substrate 3 into strip-like patterns to define detection electrodes for touch panel 31, and dividing the counter electrode 21 formed in the TFT substrate 2 into strip-like patterns or a plurality of blocks, which double as a scanning electrode for touch panel. In the liquid crystal display device shown in FIG. 1, a circuit for driving the touch panel is implemented in the LCD driver IC 5.

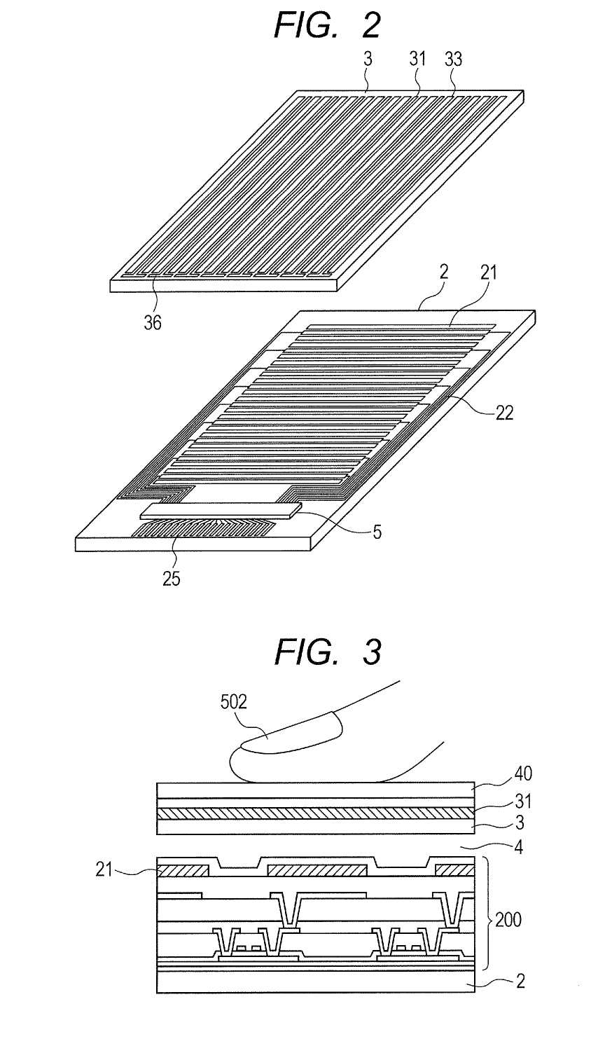

Next, the counter electrode 21 and the detection electrode 31 of the liquid crystal display device shown in FIG. 1 are described with reference to FIG. 2.

As described above, the counter electrode 21 is formed on the TFT substrate 2. A plurality of (e.g., about 32 strips of) counter electrodes 21 are mutually connected at opposite ends thereof so as to be connected to a counter-electrode signal line 22.

In the liquid crystal display device shown in FIG. 2, the strip-like counter electrodes double as the scanning electrode (Tx) while the detection electrode 31 constitutes a detection electrode (Rx).

Therefore, a counter electrode signal includes a counter voltage used for image display and a touch-panel scanning voltage used for detecting a touch position. The touch-panel scanning voltage applied to the counter electrode 21 induces a detection signal in the detection electrode 31 spaced a given distance from the counter electrode 21 and forming a capacitance. This detection signal is outputted via a terminal 36 for detection electrode.

Dummy electrodes 33 are formed on the opposite sides of the detection electrode 31. The detection electrode 31 has one end extended to the dummy electrodes 33, thus defining the T-shaped terminal for detection electrode 36. Besides the counter-electrode signal lines 22, the TFT substrate 2 is also formed with various wirings, terminals and the like such as an input terminal for driver circuit 25.

FIG. 3 shows an enlarged schematic cross-section of a part of a display portion of the liquid crystal display device shown in FIG. 1.

As shown in FIG. 3, the TFT substrate 2 is provided with a pixel portion 200 and the counter electrode 21 is used as a part of the pixel for image display. A liquid crystal composition 4 is sealed between the TFT substrate 2 and the CF substrate 3. The detection electrode 31 formed on the CF substrate 3 and the counter electrode 21 formed on the TFT substrate 2 configure a capacitance so that the detection electrode 31 is varied in voltage when a drive signal is applied to the counter electrode 21.

At this time, when a conductor such as a finger 502 approaches or touches the detection electrode via the front window 40, as shown in FIG. 3, the capacitance varies so that the voltage produced in the detection electrode 31 varies from that when the conductor does not approach or touch the detection electrode.

Thus, a touch panel function can be implemented in the liquid crystal display panel by detecting the change in the capacitance produced between the counter electrode 21 and the detection electrode 31 formed in the liquid crystal display panel.

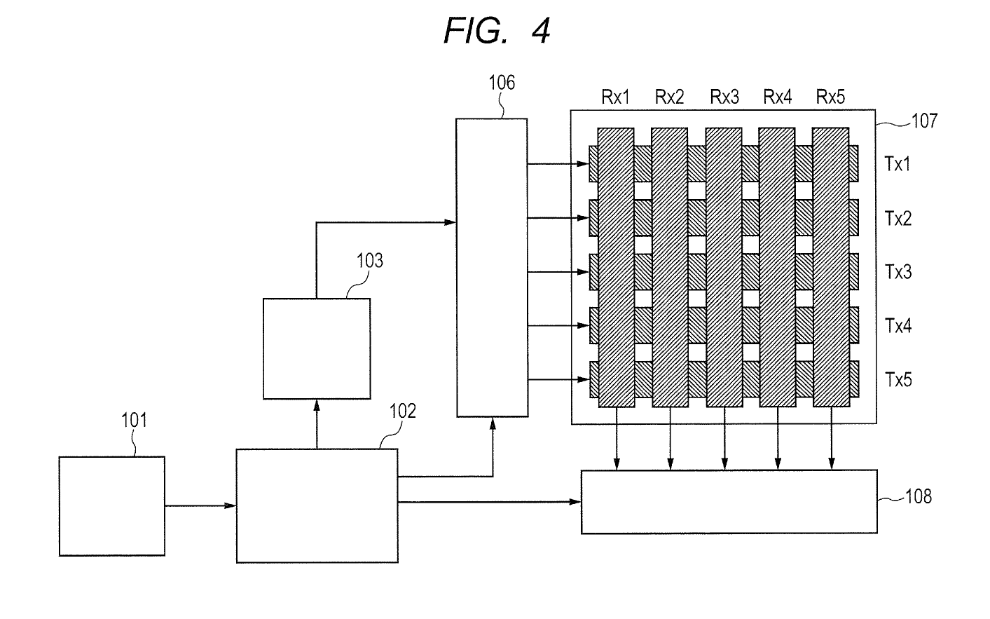

FIG. 4 is a block diagram schematically showing the overall structure of the touch panel of the in-cell type liquid crystal display device that is the premise of the invention.

In FIG. 4, an LCD driver is indicated at 101, a sequencer indicated at 102, a touch-panel scanning voltage generator indicated at 103, a decoder circuit indicated at 106, a touch panel indicated at 107 and a detector circuit indicated at 108.

The touch panel 107 is formed with electrode patterns (scanning electrodes Tx1 to Tx5, detection electrodes Rx1 to Rx5) as sensor terminals for detecting user's touch.

In the in-cell type liquid crystal display device that is the premise of the invention, the touch panel function is incorporated in the liquid crystal display panel and hence, the strip-like counter electrode 21 shown in FIG. 2 doubles as the scanning electrode (Tx) while the detection electrode 31 constitutes the detection electrode (Rx).

The LCD driver 101 outputs to the sequencer 102 a synchronization signal (vertical synchronization signal (Vsync) and horizontal synchronization signal (Hsync)). The sequencer 102 controls the timing of a touch detection operation by controlling the touch-panel scanning voltage generator 103, the decoder circuit 106 and the detector circuit 108.

The touch-panel scanning voltage generator 103 generates and outputs a touch-panel scanning voltage (Vstc) for driving the scanning electrodes Tx1 to Tx5.

The decoder circuit 106 is an analogue switch (demultiplexer) which outputs the touch-panel scanning voltage (Vstc) to one of the scanning electrodes Tx1 to Tx5 based on a selection signal inputted from the sequencer 102.

The detector circuit 108 detects an interelectrode capacitance (mutual capacitance) at an intersection between one of the scanning electrodes Tx1 to Tx5 that is supplied with the touch-panel scanning voltage (Vstc) and each of the detection electrodes Rx1 to Rx5.

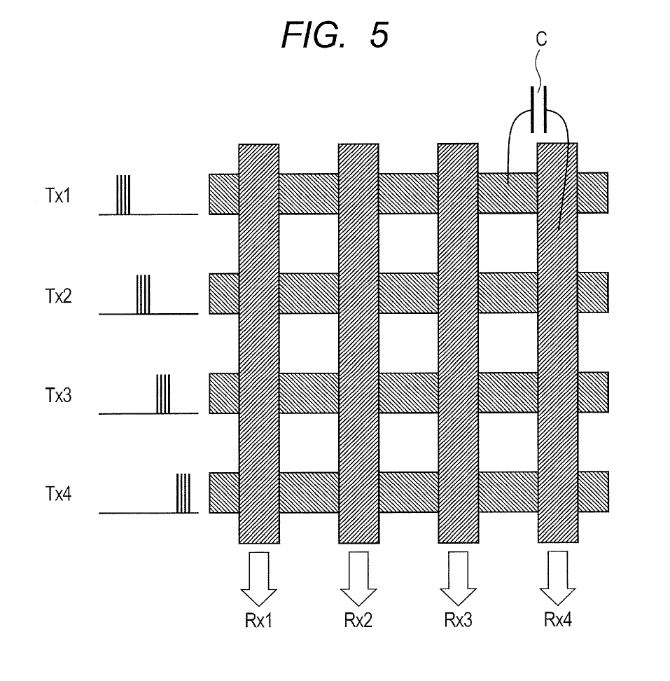

FIG. 5 is a diagram for explaining the detection principle of the touch panel of the in-cell type liquid crystal display device that is the premise of the invention.

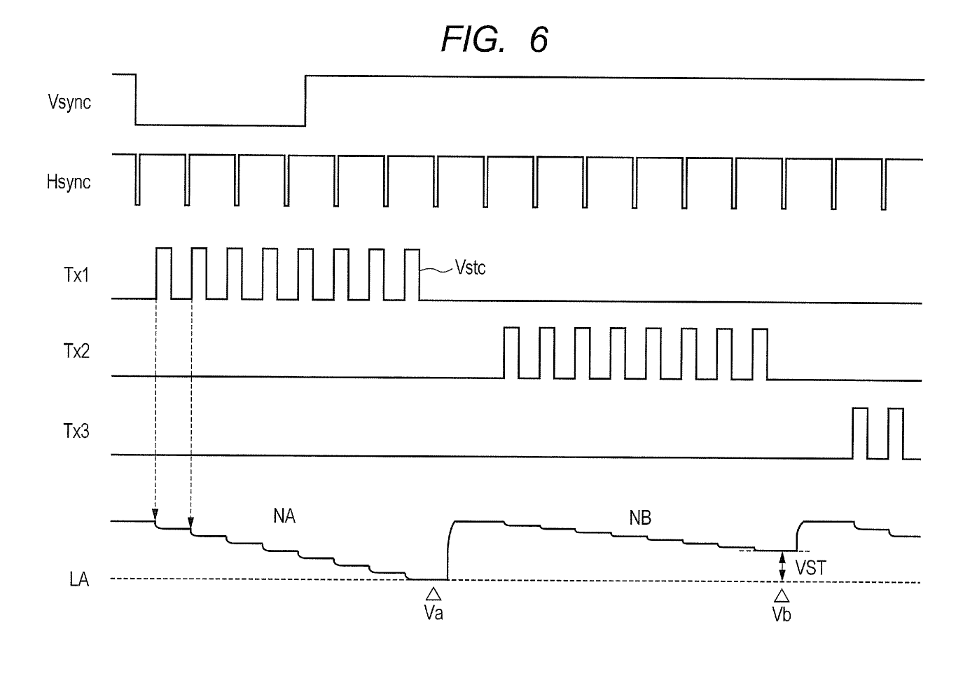

FIG. 6 is a timing chart of the touch detection operation of the in-cell type liquid crystal display device that is the premise of the invention.

The sequencer 102 controls the touch-panel scanning voltage generator 103 and the like for sequentially supplying the touch-panel scanning voltage (Vstc) to the scanning electrodes Tx1 to Tx5 in synchronism with the vertical synchronization signal (Vsync) and the horizontal synchronization signal (Hsync). As shown in FIG. 5 and FIG. 6, each of the scanning electrodes is supplied with the touch-panel scanning voltage (Vstc) multiple times (eight times as seen in FIG. 6).

As shown in FIG. 6, the detector circuit 108 integrates the values of current through the respective detection electrodes Rx1 to Rx5 (integrates in a negative direction as seen in FIG. 6) and records a reached voltage value (ΔVa, ΔVb).

In a case where the finger (conductor) touches on point near the intersection of the scanning electrode (Tx) and the detection electrode (Rx), the voltage value as the integration result varies because the current also flows into the finger.

In a case where the finger does not exist near the intersections of the scanning electrode (Tx1) and the detection electrodes (RxN), as seen in FIG. 6, for example, (non-touch state represented by ‘NA’ in FIG. 6), a voltage value as the integration result of the current through the detection electrodes is at a non-touch level (LA).

On the other hand, in a case where the finger exists near the intersection of the scanning electrode (Tx2) and the detection electrodes (RxN) (a touched state represented by ‘NB’ in FIG. 6), the current also flows into the finger so that a voltage value as the integration result of the current through the detection electrodes is higher than the non-touch level (LA). A touch position can be detected based on this amount of change (touch signal).

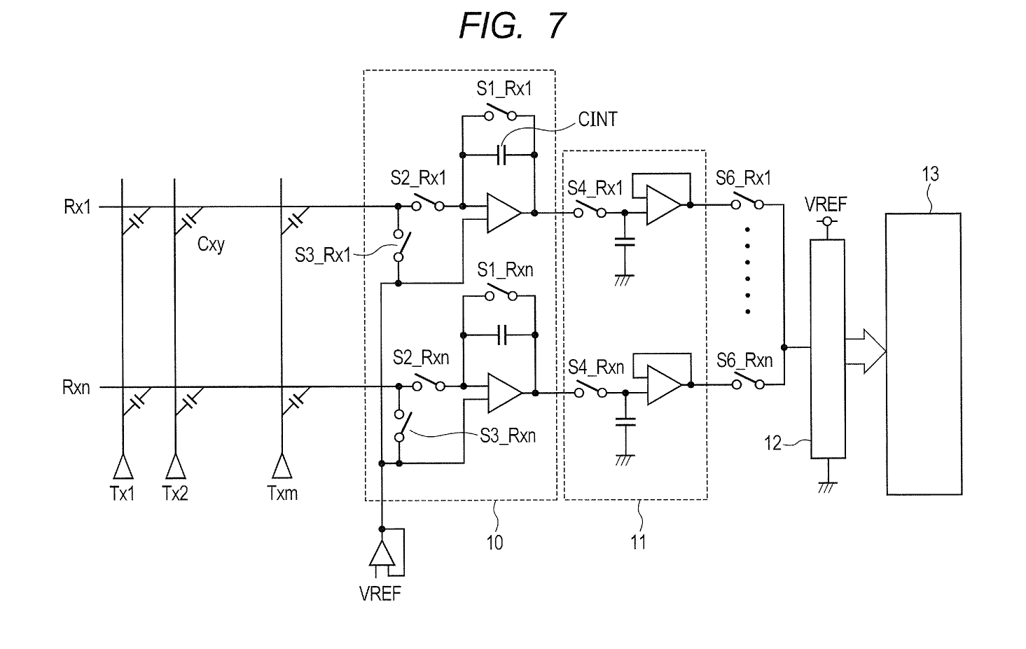

FIG. 7 is a circuit diagram showing a more detailed circuit configuration of the detector circuit 108 shown in FIG. 4.

FIG. 8 is a timing chart for illustrating the operations of the circuit shown in FIG. 7.

In FIG. 7, an integration circuit is indicated at 10, a sample-and-hold circuit indicated at 11, a 10-bit A/D converter indicated at 12 and a memory (RAM) storing data (hereinafter, RAW data) outputted from the A/D converter indicated at 13.

The operations of the circuit shown in FIG. 7 are described as below with reference to FIG. 8. It is noted that “Hsync” in FIG. 8 represents the horizontal synchronization signal.

(1) Before the current through the respective detection electrodes (Rx1 to Rx5) is detected (integrated), a switch (S1) is turned ON to reset the integration circuit 10 while a switch (S3) is turned ON to reset each of the detection electrodes (Rx1 to Rx5) (period A1 in FIG. 8).

Provided that a reference voltage (VREF) is 4V (VREF=4V), an output from the integration circuit 10 is 4V so that the detection electrodes (Rx1 to Rxn) are each pre-charged to 4V.

(2) After the switch (S1) and the switch (S3) are turned OFF, the touch-panel scanning voltage (Vstc) is outputted from one of the scanning electrodes Tx1 to Txm. In synchronism with this voltage output, a switch (S2) is turned ON to perform the integration (period B1 in FIG. 8).

This induces current flow through a path (one of the scanning electrodes Tx1 to TXm→capacitance at intersection (Cxy)→integral capacity (CINT)) so that the output voltage (VINT) of the integration circuit 10 decreases.

Here, VINT=VREF−Vstc*(Cxy/CINT)

(3) After the end of integration by the integration circuit 10, the switch (S2) is turned OFF and the switch (S3) is turned ON to pre-charge the respective detection electrodes (Rx1 to Rxn) to 4V (period A2 in FIG. 8).

(4) The voltage is cumulated by repeating the integrating operation by the integration circuit 10 in step (2) (periods B2, . . . in FIG. 8).

(5) After the end of the integration by the integration circuit 10 (after period Bn in FIG. 8), a switch (S4) is turned ON to perform a sample-and-hold operation by the sample-and-hold circuit 11 (period C in FIG. 8). Subsequently, switches (S6) are sequentially turned ON to perform A/D conversion by the A/D converter 12 and the RAW data of the scanning electrodes Rx1 to Rxn is stored in the memory (RAM) 13.

In a case where the A/D converter 12 is a 10-bit A/D converter, the RAW data ranges from 0 (integrated value 0V) to 1023 (integrated value 4V).

(6) The capacitance at intersection (Cxy) is greater when no touch on panel than when a touch on panel. As indicated by Va, Vb in FIG. 6, there is a difference in the drop of integrated output voltage (VINT) from the integration circuit 10. A threshold is provided at this difference to provide for the touch detection.

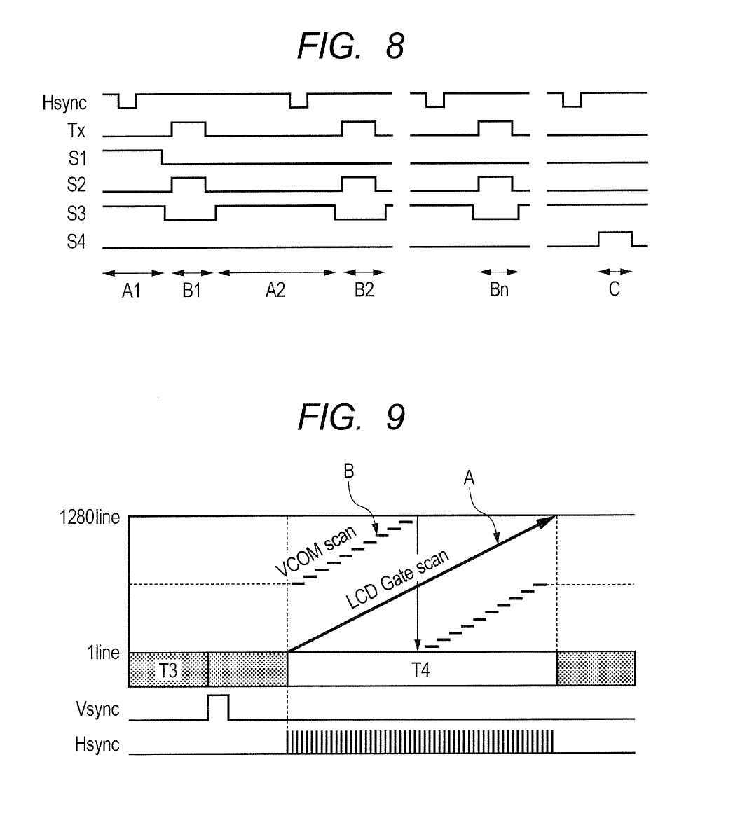

FIG. 9 is a chart for illustrating timings at which a touch-on-panel is detected and at which pixel writing is performed. In FIG. 9, T3 represents a flyback period, VSYNC representing the vertical synchronization signal, and HSYNC representing the horizontal synchronization signal.

‘A’ in FIG. 9 represents a timing at which the pixels are written from a display line 1 to a display line 1280 during a pixel writing period for one frame (T4). ‘B’ in FIG. 9 represents a touch-on-panel detection timing at which a touch-on-panel is detected by each of the counter electrodes (CT1 to CT 20) in each of the 20 divided blocks.

As shown in FIG. 9, a counter electrode of an arbitrary display line is made to function as the scanning electrode (TX). A scanning operation at the time of touch-on-panel detection is performed at a location separate from a location where gate scanning is performed for writing pixel value.

As described with reference to FIG. 9, the gate scanning and the touch-on-panel detection are performed on different display lines. However, parasitic capacitances exist between image lines and the counter electrodes (CT) and between scanning lines and the counter electrodes (CT). Therefore, detection sensitivity at the touch-on-panel detection is lowered due to the variations in the voltage on the image line (VSL) or noises produced at the rise or fall of the scanning voltage (VGL).

According to the in-cell type liquid crystal display device that is the premise of the invention, therefore, the operation of detecting a touch position is performed during a period when the voltage on the image line (VDL) does not vary or when the scanning voltage (VGL) does not rise or fall.

<Example>

The in-cell type liquid crystal display device incorporating the touch panel function is required to have a standby mode for low power consumption. In the in-cell type liquid crystal display device where the counter electrode doubles as the scanning electrode (Tx) for touch panel, a problem exists that when the scanning electrodes (Tx) are scanned with the liquid crystal display panel disabled for the display operation, a DC voltage is applied to a liquid crystal layer of the liquid crystal display panel to cause the seizing of the liquid crystal layer.

For solving the above problem, the in-cell type liquid crystal display device according to the embodiment of the invention is characterized by performing the touch detection operation by using only the detection electrodes (Rx) for the touch panel, which are formed by dividing the back-side transparent conductive film (CD) formed on the CF substrate 3 shown in FIG. 1 and FIG. 2 into the strip-like patterns.

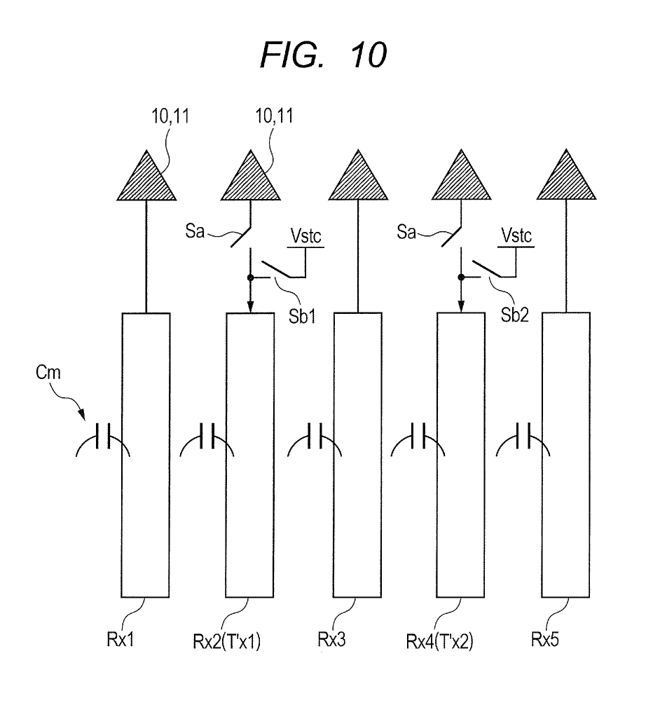

FIG. 10 is a diagram for illustrating the operation of detecting the presence of a touch in the low-power standby mode according to the embodiment of the invention.

According to the embodiment as shown in FIG. 10, out of the detection electrodes (Rx) for the touch panel which are formed by dividing the back-side transparent conductive film (CD) into the strip-like patterns, every other detection electrode (Rx) is made to function as the tentative scanning electrode (T′x) and the touch-panel scanning voltage (Vstc) is outputted to the tentative scanning electrodes (T′x).

In FIG. 10, a detection electrode (Rx2) is operated as a tentative scanning electrode (T′x1) and a detection electrode (Rx4) is operated as a tentative scanning electrode (T′x2).

By setting a register in the LCD driver 101, as shown in FIG. 10, switches (Sa) connected to the tentative scanning electrodes (T′x1, T′x2) are turned OFF and the integration circuit 10 and the sample-and-hold circuit 11 connected to the tentative scanning electrodes (T′x1, T′x2) are turned OFF.

Similarly, by setting the register in the LCD driver 101, switches (Sb1, . . . Sbn) are sequentially turned ON to supply the touch-panel scanning voltage (Vstc) to the tentative scanning electrodes (T′x1, T′x2, . . . ) in sequence. It is noted here that the tentative scanning electrodes (T′x1, T′x2, . . . ) are each supplied with the touch-panel scanning voltage (Vstc) multiple times (e.g., 64 times; 0.11 us per supply).

As described above, the integration circuits 10 other than the integration circuits 10 connected to the tentative scanning electrodes (T′x1, T′x2) integrate the values of current through the respective detection electrodes (Rx1, Rx3, . . . ) (integrate in the negative direction in the embodiment) and record the reached voltage values (ΔVa, ΔVb).

In the case where the finger (conductor) touches on the individual detection electrodes (Rx1, Rx3, . . . ) and the tentative scanning electrodes (T′x1, T′x2), or where the finger (conductor) approaches the individual detection electrodes (Rx1, Rx3, . . . ) and the tentative scanning electrodes (T′x1, T′x2), the current also flows into the finger and hence, the voltage values as the result of integration of the currents through the respective detection electrodes (Rx1, Rx3, . . . ) vary.

As described above with reference to FIG. 6, in the case where the finger is not close to the individual detection electrodes (Rx1, Rx3, . . . ) and tentative scanning electrodes (T′x1, T′x2), the voltage value as the result of integration of the currents through the respective detection electrodes is at the non-touch level (LA in FIG. 6, for example).

In the case where the finger touches on the individual detection electrodes (Rx1, Rx3, . . . ) and tentative scanning electrodes (T′x1, T′x2), on the other hand, the current also flows into the finger so that the voltage determined by integrating the currents through the respective detection electrodes (Rx1, Rx3, . . . ) is higher than the non-touch level (LA in FIG. 6, for example). The touch position can be detected based on this amount of voltage change (touch signal).

According to the embodiment, the above-described touch detection operation is performed in a cycle of 50 ms and for a touch detection period of 1.73 ms when the display device is in the low-power standby mode.

When a touch is detected in the low-power standby mode, detection information is transmitted from the LCD driver 101 to a host controller, which is shifted to a normal display and normal detection mode.

According to the embodiment as described above, when the display device is in the low-power standby mode, the touch detection operation is performed by using only the detection electrodes (Rx) for the touch panel which are configured by dividing the back-side transparent conductive film (CD) on the CF substrate 3 into the strip-like patterns. Namely, the scan of the scanning electrodes (Tx) is not performed with the liquid crystal display panel disabled for the display operation. Therefore, the seizing of the liquid crystal layer of the liquid crystal display panel caused by the DC voltage applied to the liquid crystal layer can be prevented.

According to the embodiment, when the display device is in the low-power standby mode, the integration circuit 10 and sample-and-hold circuit 11 connected to the detection electrode (Rx) functioning as the tentative scanning electrode (T′x) are turned OFF. Therefore, the electric power consumed by the detector circuit 108 is reduced by half so that the power consumption in the standby mode can be reduced even further.

The invention made by the inventors has been specifically described based on the above embodiment. It is to be noted, however, that the invention is not limited to the above embodiment and, as a matter of course, various changes and modifications may be made thereto without departing from the scope of the invention.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes which come within the meaning and range of equivalency of the claims are therefore intended to be embraced therein.

What is claimed is:

1. A liquid crystal display device having a plurality of pixels arranged in a matrix form, comprising:
a liquid crystal display panel including a first substrate, a second substrate and liquid crystal sealed between the first substrate and the second substrate,
wherein the second substrate includes a plurality of detection electrodes for a touch panel,
each of the pixels includes a pixel electrode and a counter electrode,
the counter electrode is divided into a plurality of blocks,
the counter electrode in each of the divided blocks is provided in common for the respective pixels of a plurality of consecutive display lines, and
the counter electrode in each of the divided blocks doubles as a scanning electrode for the touch panel,
the liquid crystal display device comprising means which, in a low-power standby mode, detects the presence of a touch by using only the plural detection electrodes.

2. A liquid crystal display device having a plurality of pixels arranged in a matrix form, comprising:
a liquid crystal display panel including a first substrate, a second substrate and liquid crystal sealed between the first substrate and the second substrate,
wherein the second substrate includes a plurality of detection electrodes for a touch panel,
each of the pixels includes a pixel electrode and a counter electrode,
the counter electrode is divided into a plurality of blocks,
the counter electrode in each of the divided blocks is provided in common for the respective pixels in a plurality of consecutive display lines,
the counter electrode in each of the divided blocks doubles as the scanning electrode, and
the counter electrode in each of the divided blocks is supplied with a counter voltage and a touch-panel scanning voltage,
the display device comprising:
a circuit which, in a low-power standby mode, makes every other detection electrode of the plural detection electrodes function as a tentative scanning electrode and supplies the touch-panel scanning voltage to each of the detection electrodes functioning as the tentative scanning electrode, and
a circuit which, in the low-power standby mode, detects the presence of a touch based on a detection voltage detected by the detection electrode other than the detection electrode functioning as the tentative scanning electrode.

3. The liquid crystal display device according to claim 2, further comprising a driver circuit for supplying the counter voltage and the touch-panel scanning voltage to the counter electrode in each of the divided blocks,
wherein in the low-power standby mode, the driver circuit supplies the touch-panel scanning voltage to the respective detection electrodes functioning as the tentative scanning electrode.

4. The liquid crystal display device according to claim 2, further comprising a plurality of first switch circuits which are each provided at each of the plural detection electrodes functioning as the tentative scanning electrode and connected to each of the detection electrodes functioning as the tentative scanning electrode,
wherein in the low-power standby mode, the plural first switch circuits are sequentially turned ON to supply the touch-panel scanning voltage to the detection electrodes functioning as the tentative scanning electrode.

5. The liquid crystal display device according to claim 2, further comprising a plurality of integration circuits which are each provided at each of the plural detection electrodes and connected to each of the detection electrodes,
wherein the integration circuits connected to the plural detection electrodes functioning as the tentative scanning electrode are connected to the plural detection electrodes functioning as the tentative scanning electrode via second switch circuits, and
in the low-power standby mode, the second switch circuits are turned OFF and the integration circuits connected to the plural detection electrodes functioning as the tentative scanning electrodes are turned OFF.

6. A display device having a plurality of pixels arranged in a matrix form, comprising:
a first substrate, and
a second substrate,
wherein the first substrate includes a pixel electrode and a counter electrode,
the second substrate includes a plurality of detection electrodes for a touch panel,
the counter electrode is divided into a plurality of blocks,
the counter electrode in each of the divided blocks is provided in common for the respective pixels in a plurality of consecutive display lines,
the counter electrode in each of the divided blocks doubles as a scanning electrode for the touch panel,
in a first mode where a display operation is performed, the presence of a touch is detected by the detection electrodes and counter electrodes, and
in a low-power second mode where the display operation is not performed, the presence of a touch is detected by the adjoining detection electrodes.

7. The display device according to claim 6,
wherein the counter electrode in each of the divided blocks is supplied with a counter voltage and a touch-panel scanning voltage,
the display device further comprising: a circuit which, in the second mode, makes every other detection electrode of the plural detection electrodes function as a tentative scanning electrode and supplies the touch-panel scanning voltage to each of the detection electrodes functioning as the tentative scanning electrode, and
a circuit which, in the second mode, detects the presence of a touch based on a detection voltage detected by the detection electrode other than the detection electrode functioning as the tentative scanning electrode.

8. The display device according to claim 6 , further comprising a driver circuit for supplying the counter voltage and the touch-panel scanning voltage to the counter electrode in each of the divided blocks,
wherein, in the second mode, the driver circuit supplies the touch-panel scanning voltage to each of the detection electrodes functioning as the tentative scanning electrode.

9. The display device according to claim 6, further comprising a plurality of first switch circuits which are each provided at each of the plural detection electrodes functioning as the tentative scanning electrode and connected to each of the detection electrodes functioning as the tentative scanning electrode,
wherein, in the second mode, the plural first switch circuits are sequentially turned ON to supply the touch-panel scanning voltage to the detection electrodes functioning as the tentative scanning electrode.

10. The liquid crystal display device according to claim 6, further comprising a plurality of integration circuits which are each provided at each of the plural detection electrodes and connected to each of the detection electrodes,
wherein the integration circuits connected to the plural detection electrodes functioning as the tentative scanning electrode are connected to the plural detection electrodes functioning as the tentative scanning electrode via second switch circuits, and
in the second mode, the second switch circuits are turned OFF and the integration circuits connected to the plural detection electrodes functioning as the tentative scanning electrode are turned OFF.

11. The display device according to claim 6, wherein the detection electrodes are in a stripe configuration and extended in a first direction, and
the counter electrodes are in a stripe configuration and extended in a second direction different from the first direction.

12. The display device according to claim 6, further comprising liquid crystal sealed between the first substrate and the second substrate.
